(19) United States
(12) Patent Application Publication
(10) Pub. No.: US 2018/0245757 A1
(43) Pub. Date: Aug. 30, 2018

(54) LIGHT SOURCE MODULE, ILLUMINATION DEVICE, AND MOVING BODY

(71) Applicant: PANASONIC INTELLECTUAL PROPERTY MANAGEMENT CO., LTD., Osaka (JP)

(72) Inventors: Yoshihiko KANAYAMA, Hyogo (JP); Yasuharu UENO, Osaka (JP); Hiroya TSUJI, Kyoto (JP); Tomoyuki OGATA, Osaka (JP)

(73) Assignee: PANASONIC INTELLECTUAL PROPERTY MANAGEMENT CO., LTD., Osaka (JP)

(21) Appl. No.: 15/899,949

(22) Filed: Feb. 20, 2018

(30) Foreign Application Priority Data
Feb. 27, 2017 (JP) 2017-035274

(51) Int. Cl. F21S 41/153; F21S 41/25; F21S 41/24; F21S 41/19; B60Q 1/00

(52) U.S. Cl. CPC F21S 41/153; F21S 41/25; F21Y 2115/10; F21S 41/192; B60Q 1/0076; F21S 41/24

(57) ABSTRACT

A light source module capable of reducing deformation of an outer contour shape of an illuminated image caused by influence of distortion of a projection lens is disclosed. The light source module includes a substrate, and multiple light sources mounted on the substrate and arranged in a row direction and a column direction. The light sources include a set of light sources arranged in the row direction and a set of light sources arranged in the column direction. The set of light sources arranged in the row direction includes more light sources than the set of light sources arranged in the column direction. Further, spacings between light sources included in the set of light sources arranged in the row direction are unequally set. Also, spacings between light sources included in the set of light sources arranged in the column direction are unequally set.

### CROSS REFERENCE TO RELATED APPLICATION

The entire disclosure of Japanese Patent Application No. 2017-035274 filed on Feb. 27, 2017 including specification, claims, drawings and abstract is incorporated herein by reference in its entirely.

### TECHNICAL FIELD

The present disclosure relates to a light source module, an illumination device, and a moving body.

### BACKGROUND

In Patent Document 1, there is disclosed a light emitting diode (hereinafter referred to as an LED) lighting device in which many LEDs are mounted on a substrate in a matrix, and the LEDs can be individually controlled in luminance by controlling a drive circuit connected to each LED by a control circuit.

### CITATION LIST

### Patent Literature

[Patent Document 1] JP 2009-134933 A

### SUMMARY

### Technical Problem

When being used for a vehicle headlight, the above-described LED lighting device may illuminate the front of the vehicle with light emitted from the LED lighting device through a projection lens. In this case, an outer contour shape of an illuminated image formed in the front of the vehicle is deformed into a non-similar shape to that of a light source group of the LED lighting device by influence of distortion of the projection lens, which may cause the degradation of visibility.

It is an advantage of the present disclosure to provide a light source module, an illumination device, and a moving body that are capable of reducing deformation of an outer contour shape of an illuminated image caused by influence of distortion of a projection lens, to thereby suppress visibility reduction.

### Solution to Problem

A light source module includes a substrate; and a plurality of light sources mounted on the substrate and arranged in a row direction and a column direction. The plurality of light sources includes a set of light sources arranged in the row direction and a set of light sources arranged in the column direction. The set of light sources arranged in the row direction includes more light sources than the set of light sources arranged in the column direction. Spacings between light sources included in the set of light sources arranged in the row direction are unequally set, and spacings between light sources included in the set of light sources arranged in the column direction are unequally set.

Another aspect of the present disclosure provides an illumination device using the above-described light source module. Still another aspect of the present disclosure provides a moving body using the above-described illumination device.

### Advantageous Effects of Invention

The light source module, the illumination device, and the moving body of the present disclosure enable a reduction in deformation of an outer contour shape of an illuminated image caused by influence of distortion of a projection lens, to thereby suppress visibility reduction.

### BRIEF DESCRIPTION OF DRAWINGS

Embodiments of the present disclosure will be described by reference to the following figures, wherein:

FIG. 1 is a front view illustrating an automobile on which an illumination device using a light source module according to one embodiment of the present disclosure is mounted as a headlight;

FIG. 2 is a partial sectional view of the illumination device of FIG. 1;

FIG. 3 is an exploded perspective view illustrating a light source module, a light guide member, and a projection lens when the illumination device of FIG. 1 is disassembled;

FIG. 4 is a function block diagram including the illumination device;

FIG. 5A is a front view of a light source module of a comparative example, FIG. 5B is a diagram illustrating an image illuminated by the light source module of FIG. 5A that is indicated by iso-luminance curves, FIG. 5C is a front view illustrating a light source module of a first embodiment, and FIG. 5D is a diagram illustrating an image illuminated by the light source module of FIG. 5C that is indicated by iso-luminance curves; and

FIG. 6A is a front view of the light source module of the comparative example, FIG. 6B is a diagram illustrating an image illuminated by the light source module of FIG. 6A that is indicated by iso-luminance curves, FIG. 6C is a front view illustrating a light source module of a second embodiment, and FIG. 6D is a diagram illustrating an image illuminated by the light source module of FIG. 6C that is indicated by iso-luminance curves.

### DESCRIPTION OF EMBODIMENTS

Hereinafter, embodiments according to the present disclosure will be described in detail with reference to the accompanying figures. In this description, specific shapes, materials, numerical values, directions, and the like are illustrative for facilitating understanding of the present disclosure, and can be changed according to applications, purposes, and specification. Further, if a plurality of embodiments, modifications, and the like are included in the following description, it is originally assumed that those characteristic portions are used in appropriate combination.

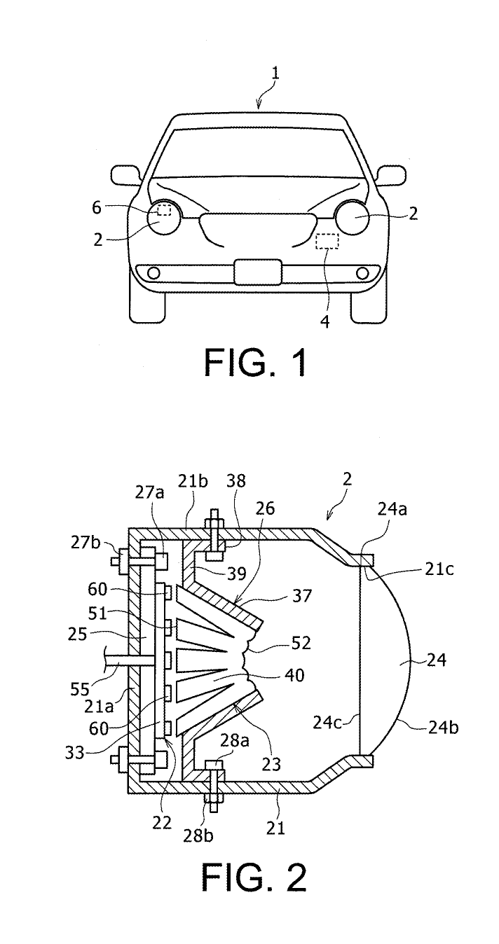

FIG. 1 is a front view of an automobile 1 on which an illumination device 2 using a light source module according to one embodiment of the present disclosure is mounted as a headlight. As illustrated in FIG. 1, the automobile 1 includes the illumination devices 2, a battery 4, and a control part 6. The illumination devices 2 are mounted on both sides in a width direction of a front end portion of the automobile 1. The battery 4 is mounted in an engine compartment of the automobile 1. The illumination device 2 is turned on by electric power supplied from the battery 4.

The control part 6 has a function of controlling turning on/off of the light source module included in the illumination device 2. The control part 6 may be provided in a case of the illumination device 2, or may be provided outside the case. If the control part 6 is provided outside the case, the control part 6 may be configured as a part of a control part integrally controlling the automobile 1.

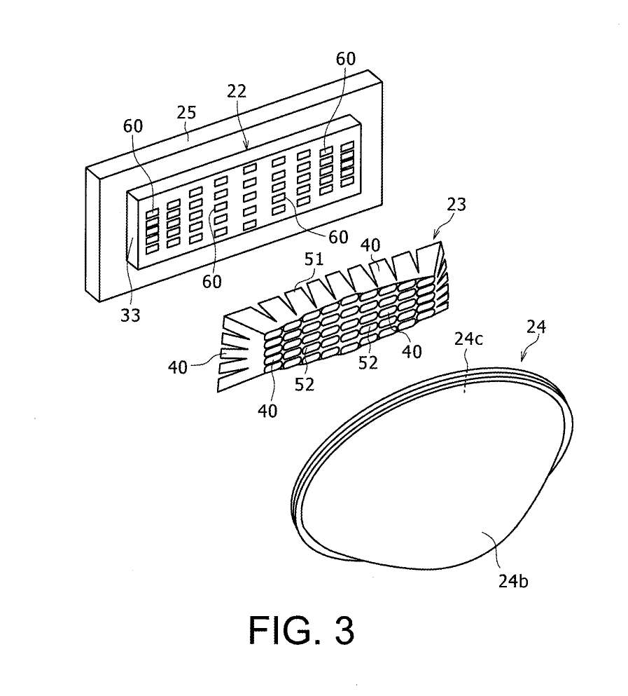

FIG. 2 is a partial sectional view of the illumination device 2. FIG. 3 is an exploded perspective view illustrating a light source module 22, a primary lens 23, and a projection lens 24 when the illumination device 2 is disassembled. Hereafter, a structure of the illumination device 2 will be described by reference to FIG. 2 and FIG. 3.

As illustrated in FIG. 2, the illumination device 2 includes the light source module 22, the primary lens 23 serving as a light guide member, and the projection lens (or a projector lens) 24, all of which are provided in a case 21. The light source module 22 includes a substrate 33, and a plurality of light sources 60 that are mounted on a front side (side facing projection lens 24) of the substrate 33 at intervals. The light source module 22 is fixed to a substrate-mounting plate 25 by a fastening member, an adhesive, or the like that is exemplified as fixing means. The substrate-mounting plate 25 is attached to, for example, a flat plate part 21a forming a bottom portion of the case 21 by, for example, bolts 27a and nuts 27b, or the like.

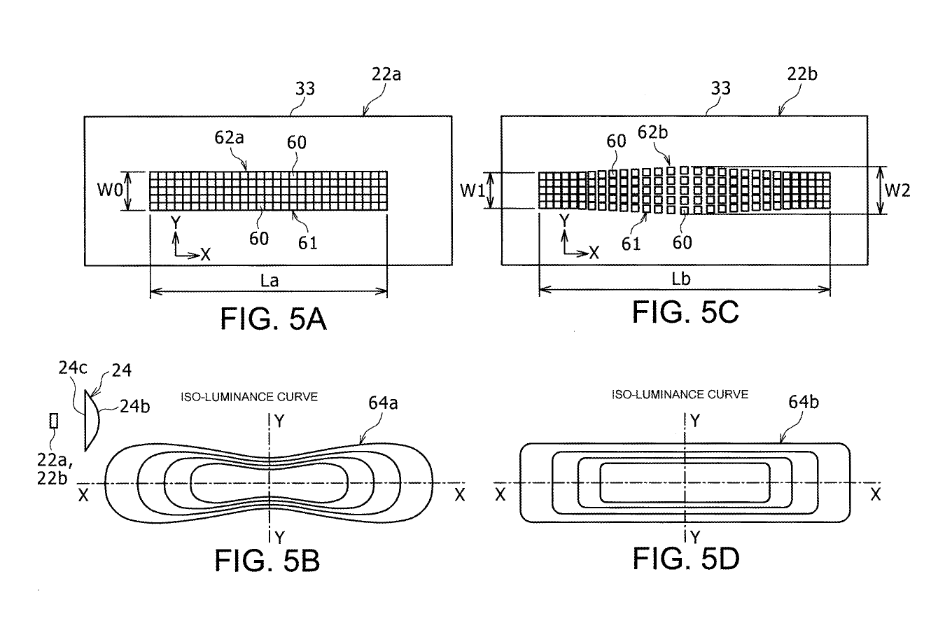

Each light source 60 of the light source module 22 is suitably constituted of a plurality of light emitting diodes (hereinafter referred to as LED). A cable 55 for supplying electric power to each light source 60 is electrically connected to the light source module 22. For example, the cable 55 passes through a through hole provided in the substrate-mounting plate 25 and a through hole provided in the case bottom portion to be led from the inside of the case to the outside of the case, and is connected to a drive circuit described later. An arrangement of the light sources 60 on the substrate 33 will be described later in detail with reference to FIG. 5C and the like. Note that the light source 60 may be constituted of a light emitting element other than the LED, e.g., a semiconductor laser element or the like.

The primary lens 23 is disposed on a light emission side of the plurality of light sources 60. The primary lens 23 has a plurality of light guide portions 40, the number of light guide portions 40 being the same as the number of light sources 60. Each light guide portion 40 includes a light incident surface 51 that is disposed on the light emission side of the corresponding light source 60, and a light emitting surface 52 that is disposed on an end portion opposite to the light incident surface 51. The plurality of light guide portions 40 are in one-to-one correspondence to the plurality of light sources 60, and each light guide portion 40 guides light emitted from the corresponding light source 60 from the light incident surface 51 to the light emitting surface 52. A peripheral portion of the end portion on the light emitting surface side of each light guide portion 40 is integrally formed together with a peripheral portion of the end portion on the light emitting surface side of the adjacent light guide portion 40. As a result, the plurality of light guide portions 40 are coupled to each other to form the integrated primary lens 23.

The primary lens 23 is fixed to a case's side wall portion 21b by, for example, a primary fixing member 26. The primary fixing member 26 includes an annular portion 37 that comes into contact with the entire side periphery of the primary lens 23 to restrain the entire side periphery of the primary lens 23, a plate-like mounting portion 38 that has a mounting surface corresponding to an inside surface of the case's side wall portion 21b, and a connection portion 39 that connects the annular portion 37 and the mounting portion 38. The mounting portion 38 is attached to the case's side wall portion 21b by bolts 28a and nuts 28b that are exemplified as fixing means so that the primary lens 23 is fixed to the case 21.

The projection lens 24 is disposed in a side opposite to the light source module 22 across the light emitting surface 52 of the primary lens 23. A light emitting side surface of the projection lens 24 is a convex surface 24b, and a light incident side surface of the projection lens 24 is a plane surface 24c. The case 21 has an opening at one side thereof in an axial direction (a normal direction of a bottom surface of the bottom portion), and a cylindrical inner peripheral surface 21c for an edge portion 24a at the one side. The edge portion 24a of the projection lens 24 is fixed to the cylindrical inner peripheral surface 21c of the case 21.

The primary lens 23 has the same number of light guide portions 40 as the number of light sources 60. The light emitted from each light source 60 enters the corresponding light incident surface 51 of the light guide portion 40, and is emitted from the corresponding light emitting surface 52 of the light guide portion 40. The plurality of light emitting surfaces 52 of the primary lens 23 are arranged corresponding to the arrangement of the light sources 60 described later with reference to FIG. 5C.

The light emitted from each light source 60 passes through the corresponding light guide portion 40 and is emitted from the light emitting surface 52 of the light guide portion 40. The light emitted from the light emitting surface 52 of each light guide portion 40 enters the plane surface 24c of the projection lens 24, and is emitted from the convex surface 24b of the projection lens 24 to the outside of the illumination device 2 to be illuminated toward the front of the vehicle.

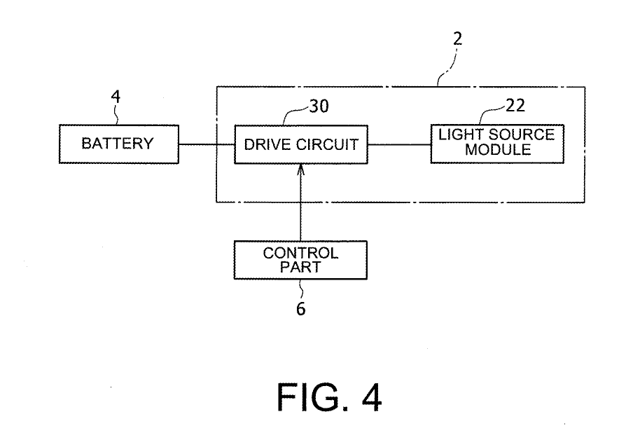

FIG. 4 is a function block diagram including the illumination device 2. As illustrated in FIG. 4, the illumination device 2 includes a drive circuit 30 in addition to the light source module 22. The drive circuit 30 is mounted on a circuit board (not illustrated), and is disposed in the case 21 of the illumination device 2.

The drive circuit 30 is electrically connected to the battery 4. The drive circuit 30 has, for example, a plurality switching parts that correspond to the light sources 60 included in the illumination device 2, respectively. Each switching part is independently on/off-controlled based on a signal output from a control part 6. Each switching part includes, for example, transistor or the like. The light source 60 corresponding to the switching part that is on-controlled by the control part 6 is supplied with the electric power from the battery 4 so that the light source 60 is turned on. The light sources 60 are individually supplied with the electric power by the drive circuit 30 so that the lighting state such as “on” or “off” of each light source 60 is controlled.

The control part 6 is suitably constituted of a microcomputer, for example. The control part 6 includes a CPU (Central Processing Unit), and storage parts such as a RAM (Random Access Memory), and a ROM (Read Only Memory). The CPU has a function of reading and executing a program or the like that is previously stored in the storage part. The RAM has a function of temporarily storing the read program and processing data. The ROM has a function of previously storing a control program, a predetermined threshold, and the like. The control part 6 can be achieved by software executed by the microcomputer, but a part thereof may consist of hardware.

Next, the light source module 22b of a first embodiment will be described with reference to FIGS. 5A-5D. FIG. 5A is a front view of a light source module 22a of a comparative example. FIG. 5B is a diagram illustrating an image illuminated by the light source module 22a of FIG. 5A that is indicated by iso-luminance curves. FIG. 5C is a front view illustrating a light source module 22b of the first embodiment. FIG. 5D is a diagram illustrating an image illuminated by the light source module 22b of FIG. 5C that is indicated by iso-luminance curves. In FIGS. 5A and 5B, a column direction of the light sources 60 is indicated by an arrow Y, and a direction orthogonal to the column direction, or a row direction, is indicated by an arrow X.

Referring to FIG. 5A, in the light source module 22a of the comparative example, the plurality of light sources 60 are disposed on the rectangular substrate 33 in a matrix. More specifically, the light source module 22a includes a total of 145 light sources 60 that are arrayed in a matrix with five rows and 29 columns, and a light source group 62a consists of these light sources 60. An outer contour shape of the light source group 62a has a rectangular shape similar to the shape of the substrate 33. That is, in the light source module 22a, a width W0 in the column direction Y of the light source group 62a is constant in the row direction X that is perpendicular to the column direction. As a result, a distribution density of the light sources 60 in the light source group 62a is constant over the entire light source group 62a. The plurality of light sources 60 includes a set of light sources arranged in the row direction X and a set of light sources 60 arranged in the column direction Y. The set of light sources 60 arranged in the row direction X includes more light sources 60 than the set of light sources 60 arranged in the column direction Y. Spacings between light sources 60 included in the set of light sources 60 arranged in the row direction X are equally set, and spacings between light sources 60 included in the set of light sources 60 arranged in the column direction Y are equally set.

When the light emitted from such a light source module 22a is illuminated through the above-described primary lens 23 and projection lens 24, the outer contour shape of an illuminated image 64a is deformed by influence of distortion of the projection lens 24 as illustrated in FIG. 5B. Specifically, by influence of distortion of the projection lens 24 having the convex surface 24b on an opposite side to the light source module 22a, the illuminated image 64a is formed widely in a vertical direction at both end regions in a horizontal direction, and is formed to be narrower in the vertical direction toward a center region in the horizontal direction. In this case, the outer contour shape of the illuminated image 64a is, for example, a gourd shape. The vertical direction Y-Y of the illuminated image 64a corresponds to the column direction Y of the light source group 62a, and the horizontal direction X-X of the illuminated image 64a corresponds to the row direction X of the light source group 62a. The outer contour shape of the illuminated image 64a is thus formed, causing the field of view to be narrow in the center region in the horizontal direction, resulting in reduction in forward visibility of the vehicle.

On the other hand, a light source module 22b of the first embodiment is formed to change an arrangement interval of the light sources 60 constituting a light source group 62b as illustrated in FIG. 5C.

Specifically, the light source module 22b has the light source group 62b in which the plurality of light sources 60 are mounted on the rectangular substrate 33, as in the above-described light source module 22a. In the light source group 62b, a plurality of light source arrays 61, each of which has the plurality of light sources 60 arrayed in the column direction Y, are arranged in the direction X orthogonal to the column direction Y along the light source array 61.

The number of light sources 60 included in the light source group 62b is 145, which are the same as the number of the light source modules 22a of the above-described comparative example. The number of light sources 60 constituting each light source array 61 included in the light source group 62b is five, which is the same as the number of the light source module 22a of the above-described comparative example. Furthermore, the light source group 62b is similar to the light source module 22a in the comparative example in that the length in the orthogonal direction X is longer than the width in the column direction Y. The plurality of light sources 60 includes a set of light sources 60 arranged in the row direction X and a set of light sources 60 arranged in the column direction Y. The set of light sources 60 arranged in the row direction X includes more light sources 60 than the set of light sources 60 arranged in the column direction Y.

The light source module 22b differs from the light source module 22a of the above-described comparative example in that the interval among the plurality of light sources 60 in the column direction Y and the interval among the light source arrays 61 gradually increase from the end regions in the orthogonal direction X of the light source group 62b to the center region in the orthogonal direction X of the light source group 62b for every one or the plurality of light source arrays 61. Spacings between light sources 60 included in the set of light sources 60 arranged in the row direction X are unequally set, and spacings between light sources 60 included in the set of light sources 60 arranged in the column direction Y are unequally set.

Specifically, in the light source group 62b, the interval among the light sources 60 constituting the light source array 61 in the column direction Y is small at both side end regions in the orthogonal direction X, but the interval among the light sources 60 constituting the light source array 61 is larger toward the center region in the orthogonal direction X. Spacing between light sources 60 located in a middle region of the set of light sources 60 included in the column direction Y is broader than spacing between light sources 60 located at an end region of the set of light sources 60 included in the column direction Y. Then, in the light source group 62b, the width W2 at the center region in the orthogonal direction X is larger than the width W1 at the end regions in the orthogonal direction X.

In the light source group 62b, the interval among the light source arrays 61 also gradually increases from the end regions in the orthogonal direction X to the center region in the orthogonal direction X for every one or the plurality of light source arrays 61. Spacing between light sources 60 located in a middle region of the set of light sources 60 included in the row direction X is broader than spacing between light sources 60 located at an end region of the set of light sources 60 included in the row direction X. Then, a length Lb in the orthogonal direction X of the light source group 62b is longer than a length La in the orthogonal direction X of the light source group 62a of the comparative example.

In the light source module 22b of the first embodiment, the intervals among the light sources 60 in the orthogonal direction X and the column direction Y gradually increase from the end regions of the light source group 62b to the center region of the light source group 62b for every one or the plurality of light source arrays 61. As a result, a distribution density of the light sources 60 on the substrate 33 is higher toward the end regions in the orthogonal direction X of the light source group 62b, and lower toward the center region in the orthogonal direction X of the light source group 62b. In other words, the distribution density of light sources 60 located in a middle region of the set of light sources 60 included in the row direction X is lower than light sources 60 located at an end region of the set of light sources 60 included in the row direction X, and the distribution density of light sources 60 located in a middle region of the set of light sources 60 included in the column direction Y is lower than light sources 60 located at an end region of the set of light sources 60 included in the column direction Y. In the light source module 22b in which the light sources 60 are thus arranged, the illuminated image 64b is projected toward the front of the vehicle by the light emitted from the illumination device 2 through the primary lens 23 and the projection lens 24, as illustrated in FIG. 5D. Since the influence of distortion of the projection lens 24 is relieved, the shape of this illuminated image 64b is corrected to a flat and rectangular shape that extends in the horizontal direction corresponding to the orthogonal direction X of the light source group 62b. Then, as being clear by comparing with FIG. 5B, an illumination width in the vertical direction is larger toward the center region in a longitudinal direction of the illuminated image 64b and the field of view is widened, thereby improving the forward visibility of the vehicle.

In the light source module 22a of the first embodiment, the interval among the light sources 60 is larger toward the center region in the orthogonal direction X, thereby enhancing the heat dissipation of the light sources 60 particularly at the center region, which may be easily dense with heat.

As described above, the light source module 22b of the first embodiment includes the substrate 33, and the light source group 62b mounted on the substrate 33, the light source group 62b including a plurality of light source arrays 61 each of which has a plurality of light sources 60 arrayed, and the light source arrays 61 being arranged in a direction X orthogonal to a column direction Y along the light source array 61. Here, the light source group 62b is formed so that the length Lb in the orthogonal direction X is longer than the widths W1, W2 in the column direction Y. The interval among the plurality of light sources 60 in the column direction Y and the interval among the light source arrays 61 gradually increase from the end regions in the orthogonal direction X of the light source group 62b to the center region in the orthogonal direction X of the light source group 62b for every one or the plurality of light source arrays 61. In other words, the distribution density of the light sources 60 in the light source group 62b is higher toward the end regions in the orthogonal direction X of the light source group 62b, and lower toward the center region in the orthogonal direction X of the light source group 62b.

This configuration enables a reduction in the deformation of the outer contour shape of the illuminated image 64b caused by the influence of distortion of the projection lens 24, the projection lens 24 having the convex surface 24b on an opposite side to the light source module 22b, thereby improving the forward visibility of the vehicle.

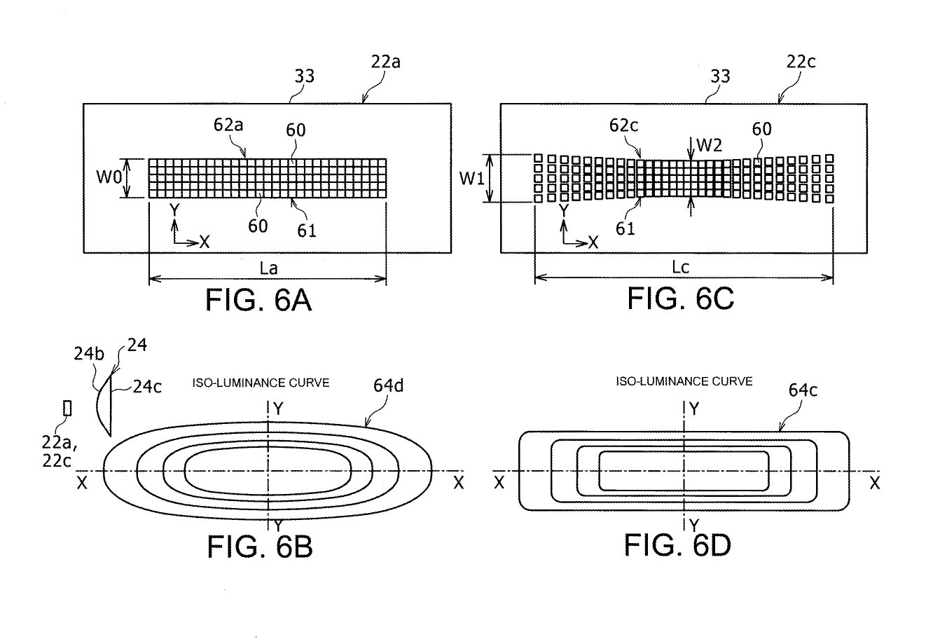

Next, a light source module 22c of a second embodiment will be described with reference to FIGS. 6A-6D. FIG. 6A is a front view of a light source module 22a of the comparative example. FIG. 6B is a diagram illustrating an image illuminated by the light source module 22a of FIG. 6A that is indicated by iso-luminance curves. FIG. 6C is a front view illustrating a light source module 22c of the second embodiment. FIG. 6D is a diagram illustrating an image illuminated by the light source module 22c of FIG. 6C that is indicated by iso-luminance curves. In FIGS. 6A and 6C, a column direction of the light sources 60 is indicated by an arrow Y, and a direction orthogonal to the column direction is indicated by an arrow X.

Referring to FIG. 6A, the light source module 22a of the comparative example is the same as that described above with reference to FIG. 5A, and a total of 145 light sources 60 are arrayed in a matrix with five rows and 29 columns.

The description will be made on the assumption that the light emitted from the light source module 22a of the comparative example is illuminated through the primary lens 23 (not illustrated here) and the projection lens 24 having the convex surface 24b facing the light source module 22a side, as illustrated in a simple diagram in FIG. 6B. In this case, the outer contour shape of the illuminated image 64d is deformed by the influence of distortion of the projection lens 24 as indicated by iso-luminance curves in FIG. 6B.

Specifically, by influence of distortion of the projection lens 24 having the convex surface 24b on an opposite side to the light source module 22a, the illuminated image 64d is formed widely to be swollen outwardly in a vertical direction at the center region in the horizontal direction, and is formed to be narrower in the vertical direction toward the end regions in the horizontal direction. In this case, the outer contour shape of the illuminated image 64d is, for example, a substantially elliptic shape. The vertical direction Y-Y of the illuminated image 64d corresponds to the column direction Y of the light source group 62a, and the horizontal direction X-X of the illuminated image 64d corresponds to the orthogonal direction X of the light source group 62a. The outer contour shape of the illuminated image 64d is thus formed to be bulged in the vertical direction, resulting in blurring of the outer edge of the illumination range and a reduction in forward visibility of the vehicle.

On the other hand, a light source module 22c of the second embodiment is formed to change an arrangement interval of the light sources 60 constituting a light source group 62c as illustrated in FIG. 6C. Specifically, in the light source module 22c, the interval among the plurality of light sources 60 in the column direction Y and the interval among the light source arrays 61 gradually decrease from the end regions in the orthogonal direction X of the light source group 62c to the center region in the orthogonal direction X of the light source group 62c for every one or the plurality of light source arrays 61, contrary to the light source module 22b of the first embodiment. Spacings between light sources 60 included in the set of light sources 60 arranged in the row direction X are unequally set, and spacings between light sources 60 included in the set of light sources 60 arranged in the column direction Y are unequally set.

More particularly, in the light source group 62c, the interval among the light sources 60 constituting the light source array 61 in the column direction is large at both side end regions in the orthogonal direction X, but the interval among the light sources 60 constituting the light source array 61 is smaller toward the center region in the orthogonal direction X. Spacing between light sources 60 located in a middle region of the set of light sources 60 included in the column direction Y is narrower than spacing between light sources 60 located at an end region of the set of light sources 60 included in the column direction Y. Then, in the light source group 62c, the width W2 at the center region in the orthogonal direction X is smaller than the width W1 at the end regions in the orthogonal direction X.

In the light source group 62c, the interval among the light source arrays 61 also decreases from the end regions in the orthogonal direction X to the center region in the orthogonal direction X. In other words, in the light source group 62c, the interval among the light source arrays 61 at the end regions in the orthogonal direction X is larger than that at the center region in the orthogonal direction X. Spacing between light sources 60 located in a middle region of the set of light sources 60 included in the row direction X is narrower than spacing between light sources 60 located at an end region of the set of light sources 60 included in the row direction X. Then, a length Lc in the orthogonal direction X of the light source group 62c is longer than the length La in the orthogonal direction X of the light source group 62a of the comparative example.

In the light source module 22c of the second embodiment, the intervals among the light sources 60 in the orthogonal direction X and the column direction Y are gradually reduced from the end regions of the light source group 62c to the center region of the light source group 62c for every one or the plurality of light source arrays 61. As a result, a distribution density of the light sources 60 on the substrate 33 is lower toward the end regions in the orthogonal direction X of the light source group 62c, and higher toward the center region in the orthogonal direction X of the light source group 62c. In other words, the distribution density of light sources 60 located in a middle region of the set of light sources 60 included in the row direction X is higher than light sources 60 located at an end region of the set of light sources 60 included in the row direction X, and the distribution density of light sources 60 located in a middle region of the set of light sources 60 included in the column direction Y is higher than light sources 60 located at an end region of the set of light sources 60 included in the column direction Y.

In the light source module 22c in which the light sources 60 are thus arranged, the illuminated image 64c is projected toward the front of the vehicle by the light emitted from the illumination device 2 through the primary lens 23 and the projection lens 24, as illustrated in FIG. 6D. Since the influence of distortion of the projection lens 24 is relieved, the shape of this illuminated image 64c is corrected to a flat and rectangular shape that extends in the horizontal direction corresponding to the orthogonal direction X of the light source group 62c. Then, as being clear by comparing with FIG. 6B, an illumination width in the vertical direction is narrower toward the center region in a longitudinal direction of the illuminated image 64c and the illumination range with clearer outer edge is formed, thereby improving the forward visibility of the vehicle.

In the light source module 22c of the second embodiment, the intervals among the light sources 60 in the orthogonal direction X and the column direction Y are larger toward the end regions in the orthogonal direction X, thereby enhancing the heat dissipation of the light sources 60 arranged at the end regions.

As described above, the light source module 22c of the second embodiment includes the substrate 33, and the light source group 62c mounted on the substrate 33, the light source group 62c including a plurality of light source arrays 61, each of which has a plurality of light sources 60 arrayed, and the light source arrays 61 being arranged in a direction X orthogonal to a column direction Y. Here, the light source group 62c is formed so that the length Lc in the orthogonal direction X is longer than the widths W1, W2 in the column direction Y. The interval among the plurality of light sources 60 in the column direction Y and the interval among the light source arrays 61 gradually decrease from the end regions in the orthogonal direction X of the light source group 62c to the center region in the orthogonal direction X of the light source group 62c for every one or the plurality of light source arrays 61. In other words, the distribution density of the light sources 60 in the light source group 62c is lower toward the end regions in the orthogonal direction X of the light source group 62c, and higher toward the center region in the orthogonal direction X of the light source group 62c.

This configuration enables a reduction of the deformation of the outer contour shape of the illuminated image 64c caused by the influence of distortion of the projection lens 24, the projection lens 24 having the convex surface 24b on the light source module 22b side, thereby improving the forward visibility of the vehicle.

Note that the light source module according to the present disclosure is not limited to the above-described embodiments and the modification thereof, and various changes and modifications can be made within matters described in the claims of the present application and within an equivalent range thereof.

In the above-described illumination device 2, the light from the light sources 60 of the light source modules 22, 22b, 22c is emitted to the projection lens 24 through the primary lens 23. However, the illumination device is not limited to this configuration. There may be provided an illumination device in which the light from the light sources 60 is emitted directly to the projection lens 24 without using the primary lens. In this case, the inner surface of the case's side wall part is preferably formed as a reflection surface such as a mirror surface. Then, the light from the light source module can be efficiently guided to the projection lens.

In the above description, the moving body on which the illumination device 2 is mounted is an automobile. However, the moving body provided with the illumination device according to the present disclosure may be a vehicle other than an automobile, such as a ship, an airplane, a robot, or the like.

### REFERENCE SIGNS LIST

1 automobile, 2 illumination device, 4 battery, 6 control part, 21 case, 21a flat plate part, 21b case's side wall part, 21c cylindrical inner peripheral surface, 22, 22a, 22b, 22c light source module, 23 primary lens, 24 projection lens, 24a edge portion, 24b convex surface, 24c plane surface, 25 substrate-mounting plate, 26 primary fixing member, 27a, 28a bolt, 27b, 28b nut, 30 drive circuit, 33 substrate, 37 annular portion, 38 mounting portion, 39 connection portion, 40 light guide portion, 51 light incident surface, 52 light emitting surface, 55, cable, 60 light source, 61 light source array, 62a, 62b, 62c light source group, 64a, 64b, 64c, 64d illuminated image

1. A light source module, comprising:
a substrate; and
a plurality of light sources mounted on the substrate and arranged in a row direction and a column direction, the plurality of light sources includes a set of light sources arranged in the row direction and a set of light sources arranged in the column direction,
wherein
the set of light sources arranged in the row direction includes more light sources than the set of light sources arranged in the column direction,
spacings between light sources included in the set of light sources arranged in the row direction are unequally set, and
spacings between light sources included in the set of light sources arranged in the column direction are unequally set.

2. The light source module according to claim 1, wherein
spacing between light sources located in a middle region of the set of light sources included in the row direction is narrower than spacing between light sources located at an end region of the set of light sources included in the row direction.

3. The light source module according to claim 1, wherein
spacing between light sources located in a middle region of the set of light sources included in the row direction is broader than spacing between light sources located at an end region of the set of light sources included in the row direction.

4. The light source module according to claim 1, wherein
spacing between light sources located in a middle region of the set of light sources included in the column direction is narrower than spacing between light sources located at an end region of the set of light sources included in the column direction.

5. The light source module according to claim 1, wherein
spacing between light sources located in a middle region of the set of light sources included in the column direction is broader than spacing between light sources located at an end region of the set of light sources included in the column direction.

6. The light source module according to claim 1, wherein
the plurality of light sources includes a plurality of rows of light sources arranged in the row direction.

7. The light source module according to claim 1, wherein
a distribution density of light sources located in a middle region of the set of light sources included in the row direction is higher than light sources located at an end region of the set of light sources included in the row direction.

8. The light source module according to claim 1, wherein
the plurality of light sources includes a plurality of columns of light sources arranged in the column direction.

9. The light source module according to claim 1, wherein
a distribution density of light sources located in a middle region of the set of light sources included in the row direction is lower than light sources located at an end region of the set of light sources included in the row direction.

10. The light source module according to claim 1, wherein
a distribution density of light sources located in a middle region of the set of light sources included in the column direction is higher than light sources located at an end region of the set of light sources included in the column direction.

11. The light source module according to claim 1, wherein
a distribution density of light sources located in a middle region of the set of light sources included in the column direction is lower than light sources located at an end region of the set of light sources included in the column direction.

12. An illumination device using the light source module according to claim 1.

13. A moving body using the illumination device according to claim 12.

14. The moving body according to claim 13 being a car.

15. The moving body according to claim 13 being a bike.

16. The moving body according to claim 13 being a train.

17. The moving body according to claim 13 being an air plane.
